(19) United States
(12) Patent Application Publication
(10) Pub. No.: US 2004/0049476 A1
(43) Pub. Date: Mar. 11, 2004

(54) Efficient data management system

(76) Inventors: Sanjay K. Sai, Algonquin, IL (US); Niranjay Kumar, Algonquin, IL (US); Nazir T. Alimohammad, Elk Grove Village, IL (US)

Correspondence Address: Mr. Sanjay, K. Sai, 2 Lake Drive Court, Algonquin, IL, 60102, US

(21) Appl. No.: 10/236,327

(22) Filed: Sep. 6, 2002

(51) Int. Cl. G06F 7/00

(52) U.S. Cl. 707/1

(57) ABSTRACT

A data management system includes a host computer, a database accessible to the host computer and a mobile computer device in communications with the host computer. The information stored on the database is dynamically updated at different frequencies. The infrequently updated portion of the information on the database is synchronized with the mobile computer device through wired connection. The frequently updated portion of the information on the database is synchronized wirelessly with the mobile computer device.

### BACKGROUND

Despite the advancement in computer technologies, much of business and government services are still relying on passing information on paper. The paper-based workflows are inherently inefficient and error prone. For business applications such as food ordering in restaurants, paper-based workflows cause long customer wait time, increase labor cost, facility and inventory expenses. For government applications such as traffic law enforcement, paper-based workflows produce extra work for both law-enforcement officers and the customers, and reduce the capability of law-enforcement officers in countering crimes and terrorism. For health applications such as doctor's medical examination and medication prescription, paper-based workflows cause unnecessary wait time, extra healthcare cost, and frequently prescription errors.

### SUMMARY

Implementations of the system may include one or more of the following. The invention system generally includes a computer in a central office, a database in connection with or stored on the computer in the central office, a mobile computer device that is capable of storing at least a portion of the data stored in the database, a printed in connection with the mobile computer device, and at least one computer terminal in connection with the computer in the central office for extracting and sending data to the computer. A docking station is provided in connection with the computer in the central office for synchronizing updated data between the mobile computer device and the computer in the central office. In the present invention, E-PAD™ refers to the mobile device as well as the associated software and hardware supporting the mobile device E-PAD™ may take different trade names for different fields of applications. OrderPAD™ is used in the fast paced restaurants. The waiters take orders on his/her OrderPAD™, and forward the orders to the kitchen wirelessly. This procedure is to make the ordering process paperless and reduce the lag time between ordering and food preparation. TickPAD™ is used by a police officer to issue speeding/violation tickets instantaneously on the spot of traffic violations. RxPAD™ is a mobile device used by a physician in the clinic for prescribing medication to the patients. RxPAD™ can be used to capture the patients' chart stored in the computer and store/retrieve patient's records electronically. RxPAD™ transforms the prescription to a paperless process.

These objects are achieved by a data management system, comprising:

a) a host computer;

b) a database accessible to the host computer, the database storing information dynamically updated at different frequencies; and

c) a mobile computer device in communications with the host computer, wherein an infrequently updated portion of the information on the database is synchronized with the mobile computer device through wired connection and the frequently updated portion of the information on the database is synchronized with the mobile computer device through a wireless connection.

An advantage of the present invention is that the information can be electronically and paperlessly transferred in workflows in a wide array of applications such food ordering, law enforcement and healthcare. As a result, the cost and time are both reduced from the conventional workflows.

Another advantage of the present invention is that by instantaneously updating task information in a central database, tasks can efficiently scheduled depending priority and customer preference. The bottlenecks in the workflows are laminated and throughput is much improved.

The system efficiently performs data transfer and data management for business applications involving distributed locations and mobile work environment. The portable device can digitize all input information at the point of service, instantaneously transfer data to and extract data from a database where the business information is stored. Different tasks in fulfilling, a service can be scheduled by an application to cut down the bottlenecks present in conventional workflows. The system provides an improved workflow for food ordering in restaurants, healthcare and law enforcement, among others.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an efficient data management system in accordance with the present invention.

FIG. 2 is a block diagram of a mobile computer device in accordance with the present invention.

FIG. 3 is a system block diagram of an efficient data management system for restaurants in accordance with the present invention.

FIG. 4 is a flow diagram for the use of a mobile computer device in the field of healthcare in accordance with the present invention.

### DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

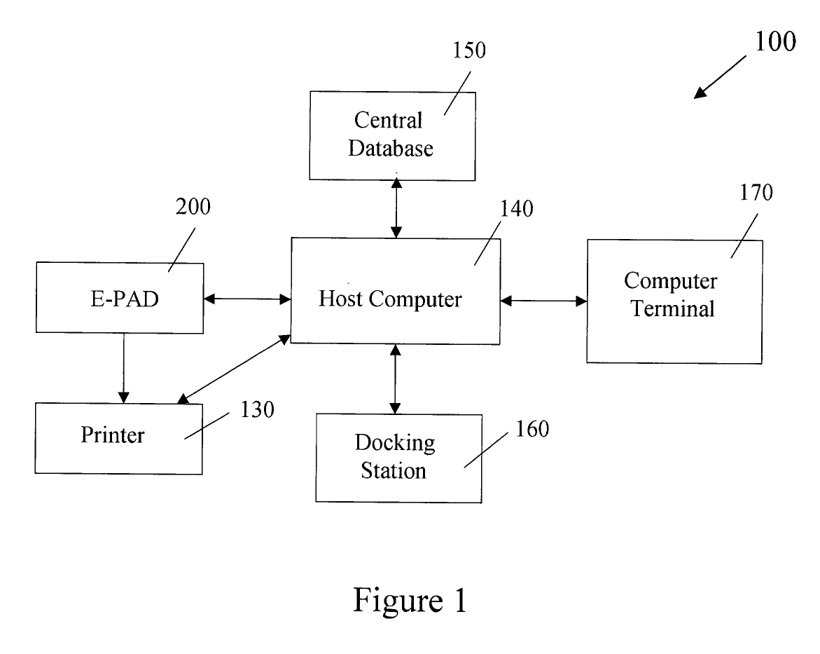

FIG. 1 shows a block diagram of the efficient data management system 100 including a mobile computer device (E-PAD™) 200, a printer 130 in connection with the mobile computer device and a host computer 140 at home office, and a central database 150 in connection with the host computer 140 in the central office. A docking station 160 is provided in connection with the host computer 140 in the central office for synchronizing updated data between E-PAD™ 200 and the host computer 140. E-PAD™ 200 is also capable of communicating with the host computer 140 wirelessly via a wide area network (WAN) or a local area network (LAN) At least a portion of the data stored in the central database 150 is stored on E-PAD™ 200. Database management software used includes Oracle or SQL server. E-PAD™ 200 can be connected with the printer with data cables or via wirelessly, depending on the applications. The host computer 140 at home office can be one or a collection of computers. The host computer 140 can be used to access the central database 150, and can also include servers to an Internet website. The website can be accessible over a private network for medical, law enforcement, and restaurant applications. In accordance with the various applications described below, the web pages hosted at the website can include various tables, forms, plots, graphics for the user access data in the central database 150 using E-PAD™ 200 in the home office or in the mobile mode.

The efficient data management system 100 can optionally further include a computer terminal 170 in connection with the host computer 140 in the central office for extracting and inputting data to the host computer 140. Preferably, the link from the host computer 140 to the computer terminal 170 over a wireless network such as Local Area Network (LAN). As will be described below, examples of the computer terminal 170 include a computer terminal in a restaurant kitchen in conjunction of OrderPAD™, a computer terminal in a Police Station or the Department of Record Keeping in Department of Transportation in the use of TickPAD™, and a computer terminal at a pharmacy with the application of RxPAD™.

An aspect of the present invention is that the information transfer from the central database 150 to E-PAD™ 200 is guided by rules based on the amount of the data, the frequency of the data update, as well as bandwidth of the communication modes. A large portion of the information is transferred from the central database 150 to E-PAD™ 200 through wired connection at the docking station. This mode of information transfer is synchronized infrequently (e.g. daily) when the E-PAD™ 200 returns to the home office. Preferably, this portion of the information comprises the majority of the information needed in applications. Another portion of the information is transferred wirelessly from the central database 150 to E-PAD™ when E-PAD™ 200 is in mobile mode. Since majority of the information is already synchronized in wired connections when E-PAD™ 200 is in the home office, only a small amount of current information needs to be synchronized in the wireless mode. This significantly reduces the amount of data transferred in the wireless communications and thus improves the work efficiency in the domain operated.

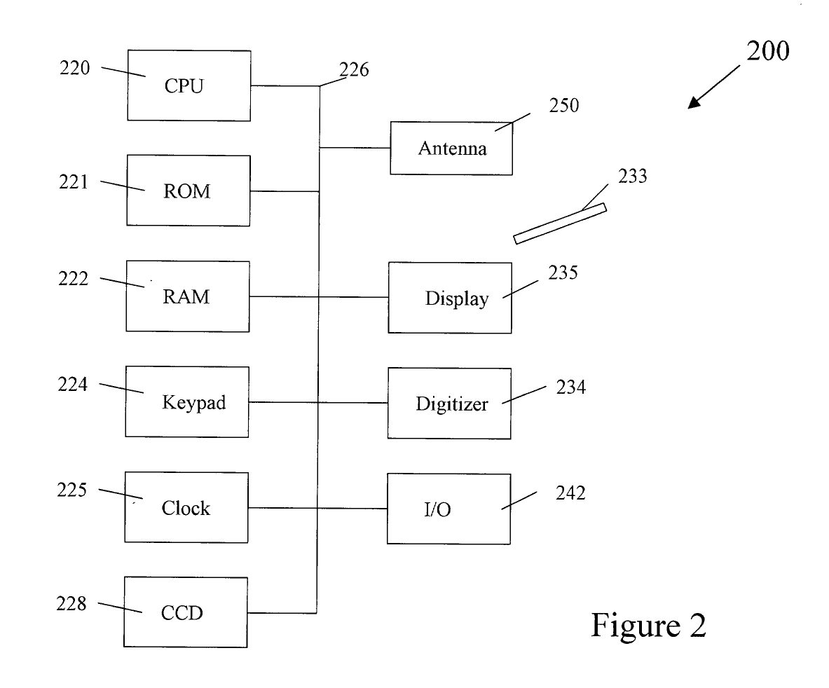

FIG. 2 is a block diagram of a mobile computer device 200 in accordance with the present invention. The processor 220 of the preferred embodiment accepts handwritings as an input medium from the user. A digitizer 234, a pen 233, and a display panel 235 are provided to capture the handwriting. Preferably, the digitizer 234 has a character input region and a numeral input region that are adapted to capture the user's handwritings on words and numbers, respectively. The display panel 235 has a viewing screen exposed along one of the planar sides of the enclosure are provided. The assembly combination of the digitizer 234, the pen 233 and the DISPLAY panel 235 serves as an input/output device. When operating as an output device, the screen 235 displays computer-generated images developed by the CPU 220. The DISPLAY panel 235 also provides visual feedback to the user when one or more application software execute. When operating as an input device, the digitizer 234 senses the position of the tip of the stylus or pen 233 on the viewing screen 235 and provides this information to the computer's processor 220. In addition to the vector information, the present invention contemplates that display assemblies capable of sensing the pressure of the stylus on the screen can be used to provide further information to the CPU 220.

The operating system running on the CPU 220 can include WIN CE and PALM OS. Applications on the CPU 220 can be written in Visual basic or VC++ source codes. The CPU 220 accepts pen strokes from the user using the stylus or pen 233 that is positioned over the digitizer 234. As the user “writes,” the position of the pen 233 is sensed by the digitizer 234 via an electromagnetic field as the user writes information to the computer system. The digitizer 234 converts the position information to graphic data. For example, graphical images can be input into the pen-based computer by merely moving the stylus over the surface of the screen. As the CPU 220 senses the position and movement of the stylus, it generates a corresponding image on the screen to create the illusion that the pen or stylus is drawing the image directly upon the screen. The data on the position and movement of the stylus is also provided to handwriting recognition software, which is stored in the ROM 221 and/or the RAM 222. The handwriting recognizer suitably converts the written instructions from the user into text data suitable for saving time and expense information. The process of converting the pen strokes into equivalent characters and/or drawing vectors using the handwriting recognizer is described below.

E-PAD™ 200 is also connected to one or more input/output (I/O) ports 242 which allow the CPU 220 to communicate with other computers. Each of the I/O ports 242 may be a parallel port, a serial port, a universal serial bus (USB) port, a Firewire port, or alternatively a proprietary port to enable E-PAD™ 200 to dock with the host computer 140. In the event that the I/O port 242 is housed in the docking station 160, after docking, the I/O ports 242 and software located on the host computer 400 supports an automatic synchronization of data between E-PAD™ 200 and the host computer 140. During operation, the synchronization software runs in the background mode on the host computer and listens for a synchronization request or command from the computer system 200 of the present invention. Changes made on the computer system and the host computer 140 will be reflected on both systems after synchronization. Preferably, the synchronization software only synchronizes the portions of the files that have been modified to reduce the updating times. The I/O port 242 is preferably a high-speed serial port such as an RS-232 port, a Universal Serial Bus, or a Fiber Channel for cost reasons, but can also be a parallel port for higher data transfer rate.

E-PAD™ 200 includes an antenna 250 for receiving and transmitting wireless signals. Signal processing applications are stored processor 220 for encoding and decoding wireless signals in various standards and protocols. E-PAD™ 200 can be in wireless communication with the host computer 140, the printer 130, and optionally the computer terminal 170. A ‘sync’ function is provided on the display panel 235 for synchronizing data between E-PAD™ 200 and the host computer 140. A ‘print’ function is provided on the display panel 235 for sending print data to the printer 130 for printing (e.g. a ticket as described below).

The wireless communication standards and protocols include Global System for Mobile Communications (GSM), General Packet Radio Service (GPRS), Enhance Data Rates for GSM Evolution (Edge), IEEE802. 11, and Bluetooth™. E-PAD™ 200 includes capabilities of automatically switching between different communication protocols when its antenna 250 detects that the signals from one mode of communication become stronger than the other modes. One or more E-PAD™ 200 can be dispersed in nearby cell regions and communicate with a cellular mobile support station (MSS) as well as a Bluetooth station. The cellular and Bluetooth stations relay the messages via stations positioned on a global basis to ensure that the user is connected to the network. The stations are eventually connected to the Internet, which is a supernetwork, or a network of networks, interconnecting a number of computers together using predefined protocols to tell the computers how to locate and exchange data with one another. The primary elements of the Internet are the host computer 140 that is linked by a backbone telecommunications network and communicate using one or more protocols. The most fundamental of Internet protocols is called Transmission Control Protocol/Internet Protocol (TCP/IP), which is essentially an envelope where data resides. The TCP protocol tells computers what is in the packet, and the 1P protocol tells computers where to send the packet. The IP transmits blocks of data called datagrams from sources to destinations throughout the Internet. As packets of information travel across the Internet, routers throughout the network check the addresses of data packages and determine the best route to send them to their destinations. Furthermore, packets of information are detoured around non-operative computers if necessary until the information finds its way to the proper destination.

The Web is based on a client/server model where Web pages reside on the host computer 140 that “serve up” pages when the user's computer (client computer) requests them. As the user “surfs” the Web, a browser can request data from the central database 150 on the server host computer 140 that processes and replies the desired data back to E-PAD™ 200 to display that request when the request is fulfilled by the server. E-PAD™ 200 runs a browser software, which asks for specific information by sending a HTTP request across the Internet connection to the host computer 140. When the host computer 140 receives the HTTP request, it responds by sending the data back to the client mobile computer, E-PAD™ 200.

The browser on the E-PAD™ 200 features a graphical user interface with icons and menus across the top along with a field to supply the URL for retrieval purposes. Navigational buttons guide the users through cyberspace in a linear manner, either one page forward or backward at a time. Pull-down menus provide a history of sites accessed so that the user can revisit previous pages. A stop button is typically provided to cancel the loading of a page. To preserve favorite sites, a bookmark is provided to hold the user's favorite URLs in a list such as a directory tree. Furthermore, the browser typically provides a temporary cache on the data storage device or in RAM. The cache allows a more efficient Internet access as it saves bandwidth and improves access performance significantly. The browser also interprets HyperText Markup Language (HTML), which allows web site creators to specify a display format accessible by HTML compatible browsers.

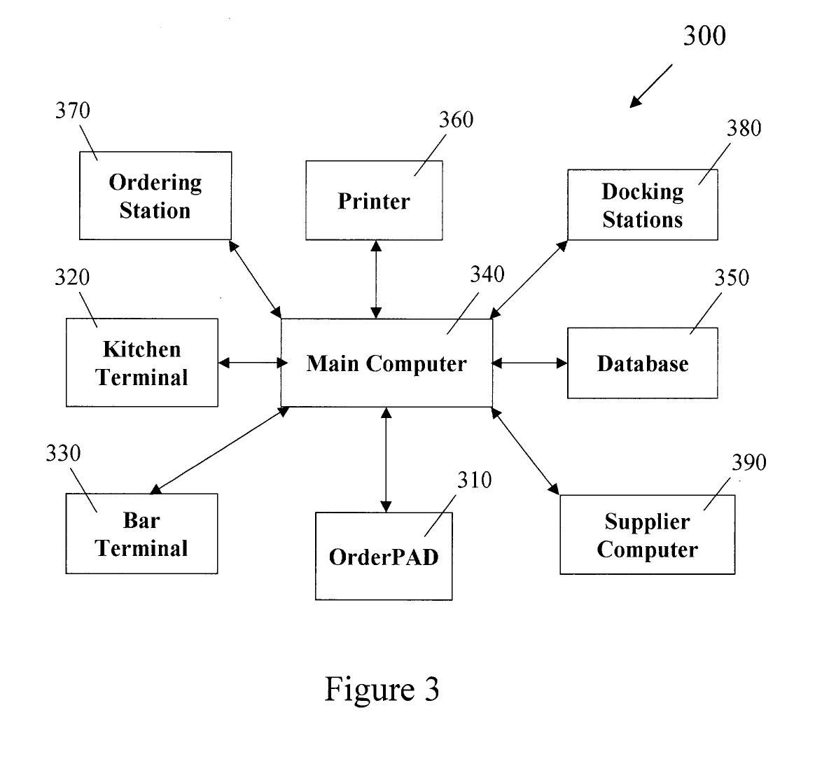

FIG. 3 illustrates an application of E-PAD™ 200 in the restaurant business in accordance with an embodiment of the present invention. The restaurant data management system 300 includes a mobile computer device (OrderPAD™) 310, kitchen terminal 320 in the kitchen, a bar terminal 330 in the bar, all in connection with a main computer 340. Preferably, the OrderPAD™ 310 is in wireless connection with the main computer 340. The main computer 340 is connected to database 350, a printer 360, an ordering station 370, and a remote supplier computer 390. The main computer 340 may be located in the front desk or an office in the restaurant. Furthermore, the OrderPAD™ 310, the kitchen terminal 320, the bar terminal 330, the main computer 340, the database 350, the printer 360, and the ordering station 370 can be all connected via a Local Area Network (LAN) which allows direct communication between each pair of devices. The connections between the devices described above can be all wireless over a wireless Local LAN. The kitchen terminal 320 and the bar terminal 330 include a touch-tone display for both display and information input. OrderPAD 310 can also take touch tone as well as pen-stylus based input for data transmission to the kitchen terminal and vice versa.

A plurality of docking stations 380 is connected with the main computer 340. OrderPAD™ 310 is docked on the docking station 380 after a waiter-joins duty or reports to work. A large portion of the information is synchronized between the database 350 and OrderPAD™ 310. The information for such infrequent updates can include new menu, new pricing information, promotions etc. When a waiter starts his or her shift, he or she removes any OrderPAD™ 310 from the docking station He or she enters his or her identification number into the OrderPAD™ 310. That OrderPAD™ 310 will automatically begin to record the waiter's services. Since majority of the information is already synchronized in wired connections when OrderPAD™ 310 is in the main computer 340, only a small amount of current information needs to be synchronized in the wireless mode. This significantly reduces the amount of data transferred in the wireless communications and thus improves the work efficiency in the fields.

The restaurant data management system 300 is provided to improve the efficiency in a fast paced restaurant. The objective is to make the food ordering paperless, the flow of the information instantaneous, and the various tasks efficiently scheduled. In accordance to the present invention, the term “restaurant” refers in general any retail food services including formal dining restaurants, fast-food restaurants, cafeteria in a company or an institution, food services in an entertainment facility such as theme park or cruise ship, etc.

The example of the workflow in a formal restaurant is now described in accordance with the present invention. A waiter carries an OrderPAD™ 310 (in place of a paper order pad) while he serves the customers at dining tables. The OrderPAD™ 310 includes a menu for all the food items available in the restaurant such as appetizers, drinks, soups, entrees, desserts, special of the day etc. While the waiter receives orders from the customers, the waiter enters the order information on the OrderPAD™ 310 using a touch-screen keypad 224 or a stylus pen 233 on display 235. The OrderPAD™ 310 can contain information of the inventory of raw food materials in the kitchen. For example, OrderPAD™ 310 can check the availability of fresh seafood in the inventory before confirming a seafood order. When the ordering is completed, the order information is transferred to the main computer 340. The order information includes drinks, beverages, dishes, soups, table number, customer seat location at each table, as well as customer preferences about their orders. For example, some customers want to finish the meal fast and have the food quickly delivered. Some other customers may want to delay the food delivery so they can chat for a longer time. Some customers may want to delay certain dishes or have drinks come with the dishes. The customers can also specify preferred payment method The food order information is instantly updated on the display of the kitchen terminal 340. The drink and beverage orders are sent to the bar terminal 330. The order information is also updated on the database 350 and saved on the OrderPAD™ 310.

In accordance with the present invention, a scheduling software application is stored on the main computer 340. Commercial scheduling software is available, for example, at Intellisoft, Inc., Miami, Fla. 33122. Upon receiving ordering information from the OrderPAD™ 310, the scheduling software application schedules all cooking jobs for the most efficient use of kitchen resource and best customer satisfaction. The parameters that the scheduling software application uses for such optimization may include the number of chefs and cooking stove in the kitchen, the number of dining tables, the number of customer groups, the customer preferences for each item's delivery time, the time that takes for each dish to be delivered, etc.

When food is ready for a particular table, the chef in the kitchen will notify the status of the particular food ordered by updating at the kitchen terminal 320 by way of touch tone screen or by pen-stylus based input. The status information is automatically sent wirelessly to the OrderPAD™ 310 of the corresponding waiter and updated on the database 350. An audio signal may be played by the OrderPAD™ 310 to alert the waiter that the food is ready for pick-up. While the food is delivered, the customers can always order more food or drinks. Since the order information is saved on the OrderPAD™ 310, the waiter can easily add more items to the existing order on the OrderPAD™ 310. When a whole order is completed, the billing information is automatically summarized on the main computer 340. A receipt is printed on the printer 360. The printer 360 can be a portable printer that is carried by each waiter such that the receipt can be printed by the waiter at the customers' dining table.

The main computer 340 is connected to the supplier computer 390 so that the supplier is regularly (e.g. every hour) updated with the consumption of food items so that the supplier can properly schedule the delivery before any item is used up.

The owner or manager can query the main computer 340 and can print reports like daily sales of a particular menu item, analyze the results of a change in menu, and forecast future trends. The owner or manager can also track each waiter's working hours and the number customers he has serviced. Reports can be also printed for the amount of sales, and taxes etc.

A variation of the OrderPAD™ 310 is an ordering station 370 that is fixed in location. For example, the ordering station 370 can be located at the customer dining table so that the customers can order food and beverages by themselves without waiting for the waiter. The waiter in this arrangement can play a consultant role for consulting the customers for their food selections. When the food is ready, the waiter can delver it or beep the particular customer table so that the customers can pick up the food or beverage by themselves. The ordering station 370 can also be a KIOSK located near the wait line. The customers can place and pay for their orders while they wait to be seated. The food order will be linked to a table number by the waiter using the OrderPAD™ 310 once a table is assigned to the group of customers. The customer can pay with a credit card by swiping on the ordering station 370 right at the table. The display on the ordering station 370 can display news, commercials, stock updates, and new food items while the customer is waiting at the table. The ordering stations are most suitable to fast food restaurants. This ordering station 370 can also be at each customer table attached to the table or ingrained in the wall beside the customer dining table for easy access.

In summary, the restaurant data management system greatly improves the efficiency of the restaurant business while simultaneously enhances customer satisfaction.

Another embodiment of the present invention is the applications of the mobile computer device 200 (E-PAD™, which can also be called TickPAD™ for this application) in the areas of law enforcement. In accordance with the present invention, referring still to FIG. 1, E-PAD™ 200 is designed for law enforcement officials working in a mobile environment. E-PAD™ 200 enables law enforcement officials to carry much of the data stored at home station to the field and thus improves the efficiency of various tasks. The application of E-PAD™ 200 is illustrated below in an example of improved workfiow in ticket issuance for speeding and traffic violations. E-PAD™ 200 is a portable computer device. Before a police officer goes out to the fields to patrol traffic, E-PAD™ 200 is docked at the docking station 160 wherein driver and vehicle information are automatically synchronized from the central database 150 to E-PAD™ 200. The driver information includes a driver's license number, address, driving record, age, gender, ethnicity, and a facial image, etc. The vehicle information includes Vehicle Identification Number (VIN), the make and the year of the vehicle, registration number, owner information, insurance information, inspection status, accident records, past due traffic tickets etc. Information transferred from the central database 150 to E-PAD™ 200 can also include list of stolen vehicles and vehicles involved in criminal activities. Ticket templates for the state of the police officer's jurisdiction are also stored on the E-PAD™. All the information can also be acquired dynamically from the host computer 140 in the central database 150 at the request of the law enforcement officers and it will be transmitted in real time to the EPAD 200. There is always a dynamic wireless link between central database 150 and EPAD 200 for the purpose of data transfer When the police officer goes out to the field he or she carries the portable E-PAD™ 200 with them. A portable printer 130 is also carried with the police officer, for example, in the police vehicle. Am example of the portable printer is a portable inkjet printer manufactured by SIPIX, located at Milpitas, Calif. When a traffic violation is found by the police officer, the officer enters the vehicle registration number and/or the driver's license number. The appropriate ticket form for the traffic violation is opened up on the E-PAD™ display. The specific vehicle and driver information are automatically filled in the form. Proper fines or warning is selected by the police officer. The ticket information is saved on E-PAD™ 200, which is to be synchronized later with the central database 150. The police officer prints out the ticket at the printer 130 and hands it to the traffic violator. An advantage of the present invention is that the ticket issuance process is time efficient. The traffic-violating motorist does not wait for long for tickets.

In another aspect of the present invention, the E-PAD™ 200 allows the traffic-violating motorist to opt to pay for the ticket fines with a credit card or bankcard on spot. The credit card information can be entered manually or swiped using a magnetic reader. The ticket issuance and payment cycle time is further reduced.

In accordance to the present invention, the information about the newly issued tickets can be instantaneously transmitted to the central database 150 via wireless communication from the E-PAD™ 200—to the home office. To update information to and from the central database 150, the police officer simply presses the ‘sync’ button of the E-PAD™ display panel. Since a multiple of police officers can access and update the central database 150 during the day, the current information is timely shared among all police officers in the fields at any time. This capability helps to alert police officers against multiple violators in each day and certain criminal activities.

After the police officer returns to his home office, he or she docks the E-PAD™ 200 at the docking station 160 to synchronize data he or she entered during the field trip and also receives updates from the central database 150. The docking station 160 also charges the electric power of the batteries in E-PAD™ 200.

Another embodiment of the present invention is the applications of E-PAD™ in the areas of healthcare. In accordance with the present invention, RxPAD™ is designed for improving the work efficiency of clinical and prescription processes. RxPAD™ is a device (note pad/PDA) to be used by a physician in the clinic to prescribe medication to the patient. RxPAD™ can communicate via wired connection with a main computer in the doctor's office. Alternatively, RxPAD™ can communicate wirelessly with the main computer through a wireless LAN. Past patients medical charts are pre-stored in the main computer in the doctor's office. The main computer (also called the base computer) is used by the secretaries, the assistants, and the doctors. User accounts are created by the system administration.

A client application runs on the RX-PAD™. The client application is deployed on an iPaq PocketPC running Wince 3.0. The base station (the main computer) can be a desktop PC for entering schedules etc. The database can be a SQL Server 2000 or a Window 2000 Server. The communications between the base and database will take place using a client application. A server is provided so that the database can be hosted on a separate personal computer. Both the database and the base can be distributed (e.g. in large hospitals). In small premises the database and base will be installed on the same computer. The client user interface on RX-PAD™ includes forms for data entry, and a handwriting control to enter freeform scribbles and typed text The user interface at the base computer uses regular Windows application or Webapp. The communications between the client RX-PAD™ and the base station (the main computer) will include two modes of operation: a) always online and b) offline mode. The always-online mode assumes 24/7 connectivity, provided by a wireless link between RX-PAD™ and the base station, This will be provided by a wireless LAN running in the doctor office. In this mode, all data entered on the handheld can be immediately synchronized with the base over the LAN. The data from the base station are instantly downloaded to the RX-PAD™. Docking will be used only for transferring large amount of data. The RX-PAD™ client and the base station will be protected from anonymous access. To use the system, user needs to logon. This logon will be enforced by the operating system on the base as well as the client application.

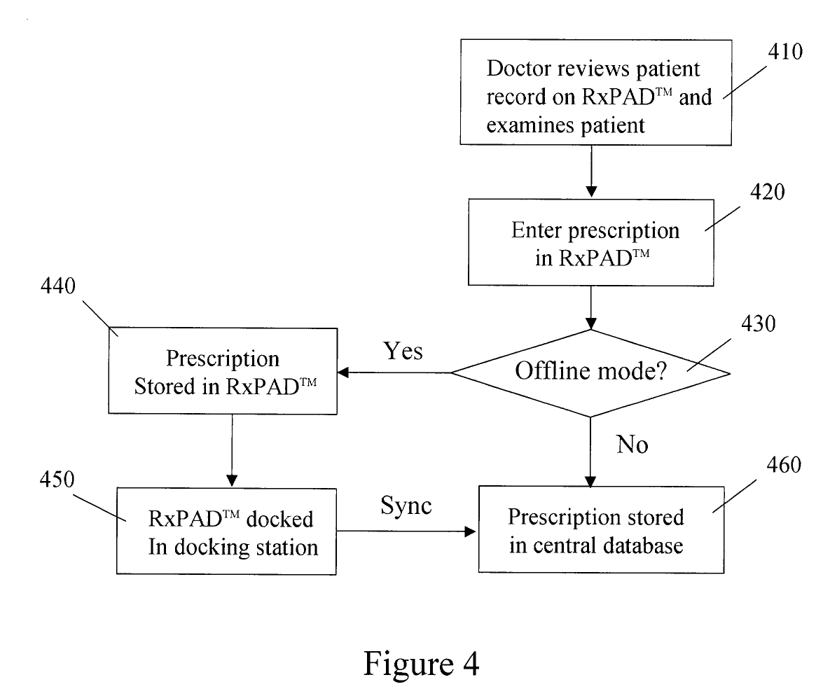

The flow diagram of a doctor's use of RxPAD™ is shown in FIG. 4. Before each day of work, the doctor logs into his or her account. To authenticate the login, the handheld accesses the user account stored on the central database. The doctor inserts the RxPAD™ in the docking station and log into the database to gather the scheduled appointment for the day and the information about the patients for that day. RxPAD™ is synchronized with a database stored on a main computer in the office. The patient information includes the patient name, age, gender, medical history, current prescriptions the patient is taking, and appointment history, etc. The data stored on RxPAD™ for the doctor that logged in is a subset of the full data in the database. Other data stored in the database include a list of doctors, a list of patients, a list of prescriptions, a list of insurance providers, a list of pharmacies, doctors'schedules, patient history, user accounts Each of these will be a separate data table. The database schema is fully normalized.

After a patient checks in at the front desk, the secretary updates the check-in status that can be wireless updated the doctor's RxPAD™ while the doctor may be seeing another patient. If this is a new patient, the secretary enters patient personal data, medical history, and reasons for the visit and insurance information. A nurse brings the patient for prescreening to measure weight, blood pressure, heart beat etc The nurse enters the data in the template that shows up on screen of RxPAD™. If it is a revisit, the existing file is updated. The status of the prescreening is also updated on the doctor's RxPAD™. The file of the patient who just checked in is automatically opened and displayed on the doctor's RxPAD™ For security, a verification may be required by cross checking the social security number of the patient. The doctor reviews the patient history and examines the patient (box 410). After the examination, the doctor records his note for the current visit in the patient chart, and prescribes medicine on the RxPAD™ using a stylus pen 223 (box 420). A comprehensive list of medications is pre-stored on RxPAD™ for the doctor to select and prescribe the dosage for the patient. The doctor can also edit existing prescriptions for the patient. These prescriptions can contain both handwriting and typed text. The prescription is saved on RxPAD™. RxPAD™ checks whether it is offline mode or in wireless connected mode (box 430). If it is not in offline mode, the prescription and the updated patient's chart are automatically wirelessly sent to the main computer and updated on the database (460). If it is offline, the doctor places the RxPAD™ in the docking station (450) to update the prescription and the updated patient's chart with the main computer (460).

After the doctor visit is finished, the patient sees the receptionist, makes co-payment. A request for medication to be sent to a particular pharmacy pre-selected by the patient. The request file contains the patient name, doctor's license information, prescription information, refill information, insurance information and payment information, etc. The information for each patient is contained in an XML (Extensible Markup Language) document and sent to the patient specified pharmacy using Web Services. The pharmacy *e.g. Walgreen) provides a web service running at an advertised URL (such as “RxPAD.walgreens.com”) This web service exposes a SOAP interface with a number of methods such as Submit Prescription, with the XML document being passed as a parameter. The pharmacy receives the prescription file, prepares the medication, and sends an electronic confirmation to the patient. The Simple Object Access Protocol (SOAP) method will return prescription fulfillment status to the client application on the main computer in the doctor's office. The patient receives the confirmation and plans his trip to the pharmacy to pick up the prescribed medication. The web method invocation will be implemented over https (secure HTTP) to guarantee security. In addition, all parameters will be encrypted for security of personal medical information.

An advantage of the prescribing medical prescription on an RxPAD™ is that the prescription and medical ordering become much more convenient comparing to the conventional paper prescription process. Another advantage of the prescribing medical prescription on an RxPAD™ is that the errors associated with unclear handwriting and reading of the handwritten prescription is much reduced. The negative effects of such errors are therefore avoided

In accordance with the present invention, E-PAD™ can be used in various other applications. E-BookPAD™ is used for students/teachers to carry paperless books. Students can have different memory modules for different books and can insert it into a PDA to view and take notes CarPAD™ is used by CAR sales man/women to store details about the Cars that they want to show it to their clients in a PDA. RealtorPAD™ is used by real-estate agents to store listings of home for sale so they can access home listings in a particular area when they go out to show listings for a particular zip code/area. RealtorPAD™ can be used for searching homes in certain price range, the number of bed rooms and bath rooms, home style (single, condo, duplex etc.), or locations. RealtorPAD™ can also assist the realtor to plan for the home showing tour for a particular client. E-GuidePAD™ is used by rental car agencies to store information about the driving directions, hotels, the city, places of interest, restaurants, gas stations and weather forecast. It can also include games and capability for making phone calls.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

### Element Number List

100 efficient data management system

130 printer

140 host computer

150 central database

160 docking station

170 computer terminal

200 mobile computer device (E-PAD™)

220 computer processor

221 Read Only Memory (ROM)

222 Random Access Memory (RAM)

224 keypad

225 real-time clock/timer

226 bus

228 Charge Couple Device (CCD) sensor

233 stylus pen

234 digitizer

235 display

242 input/output ports (I/O)

250 antenna

300 restaurant data management system

310 Order-PAD™

320 kitchen terminal

330 bar terminal

340 main computer

350 database

360 printer

370 ordering station

380 docking station

390 supplier computer

Doctor reviews patient record on RxPAD™ and examines patient

Enter prescription in RxPAD™

Offline mode?

Prescription stored in RxPAD™

RxPAD™ docked in docking station

Prescription stored in central database

What is claimed is:

1. A data management system, comprising.
a) a host computer;
b) a database accessible to the host computer, the database storing information dynamically updated at different frequencies; and
c) a mobile computer device in communications with the host computer, wherein an infrequently updated portion of the information on the database is synchronized with the mobile computer device through wired connection and the frequently updated portion of the information on the database is synchronized with the mobile computer device through a wireless connection.

2. The data management system of claim 1 further including a printer coupled to the mobile computer device, the printer being capable of printing information under the control of the mobile computer device.

3 The data management system of claim 1 further including a computer terminal in connection with the host computer for transferring data to and from the database.

4. The data management system of claim 1 further including a docking station in connection with the host computer for transferring data to and from the mobile computer device to synchronize data stored on the mobile computer device can be synchronized with the database.

5. The data management system of claim 1 further comprising traffic-law enforcement information, wherein the infrequently updated portion of the information on the database includes driver and vehicle information and the frequently updated portion of the information on the database includes ticket issuance information.

6. The data management system of claim 1 further comprising information for food ordering in restaurants, wherein the infrequently updated portion of the information on the database includes information about the menu, food pricing, the dining tables and the kitchen, and the frequently updated portion of the information on the database includes information about the customer orders and the status of the customer orders.

7. The data management system of claim 1 further comprising healthcare information, wherein the infrequently updated portion of the information on the database includes patient identity and medical history, and the frequently updated portion of the information on the database include a prescription of medication from a current examination.

8 The data management system of claim 7 wherein the prescription information is electronically transferred to a pharmacy for fulfilling the prescription.

9. The data management system of claim 7 wherein the mobile computer device receives doctor's note from each medical examination and updating it to the database.

10. A restaurant data management system, comprising:
a) a mobile computer device to receive order information from a customer;
b) a main computer in wireless communications with the mobile computer device to receive the customer order information from the mobile computer device; and
c) a database in communication with the main computer to store the customer orders information.

11. The restaurant data management system of claim 10, further including an interactive terminal in communication with the main computer to update the status of the preparation of the food and beverages.

12. The restaurant data management system of claim 10, further including an immobile ordering station in communication with the main computer for the customers to enter orders information.

13. The restaurant data management system of claim 10 wherein the main computer includes a software application to produce a schedule for preparing and delivering customer orders.

14. The restaurant data management system of claim 10 wherein the main computer is in communication with a supplier computer for updating the supplier the status of the inventory at the restaurant.

15. The restaurant data management system of claim 10 wherein the customer order information includes one of food order information, drink information, customer seating information, or customer order preference.

16. A data management system for law enforcement, comprising:
a) a central database to store driver and vehicle information;
b) a main computer in connection with the central database to access data in the central database and enter updated information into the central database; and
c) a mobile computer device in wireless communications with the main computer device for a law enforcement official to exchange information with the main computer and the central database.

17 The data management system of claim 16 wherein a portion of the information in the central database is stored on the mobile computer device, the portion of the information including at least one driver's license number and at least one Vehicle Identification Number.

18. The data management system of claim 16 wherein the mobile computer device further comprises electronic ticket forms.

19. The data management system of claim 16 further including a portable printer under the control of the mobile computer device, said portable printer capable of printing a ticket after a law-enforcement official issues a ticket using the electronic ticket form on the mobile computer device.

20. The data management system of claim 16 wherein the mobile computer device includes means for receiving payment for a ticket after a tick is issued by a law-enforcement official.
